(19) United States
(12) Patent Application Publication
(10) Pub. No.: US 2019/0123467 A1
(43) Pub. Date: Apr. 25, 2019

(54) Female Cabling Connector

(71) Applicant: Simon Simmonds, San Diego, CA (US)

(72) Inventor: Simon Simmonds, San Diego, CA (US)

(21) Appl. No.: 15/772,602

(22) PCT Filed: Nov. 2, 2016
(86) PCT No.: PCT/US16/60165

§ 371 Date: May 1, 2018

Related U.S. Application Data
(60) Provisional application No. 62/249,678, filed on Nov. 2, 2015.

(51) Int. Cl. H01R 13/187; H01R 13/11; H01R 13/33

(52) U.S. Cl. CPC H01R 13/187; H01R 13/33; H01R 13/111

(57) ABSTRACT

An electric receptacle adapted for insertion and electric engagement of a cylindrical male electric connector is provided. The receptacle employs an annular body defining an axial receiving cavity for the male connector. An angled annular polymeric insert at a leading edge may provide a guide into the receiving cavity which is preferably shaped to form a hyperbolic cylindrical grid structure from a plurality of shaped wires running in parallel paths.

This application claims priority to U.S. Provisional Application Ser. No. 62/249,678 filed on Nov. 2, 2015, which is included herein in its entirety by this reference thereto.

### BACKGROUND OF THE INVENTION

### 1. Field of the Invention

The present invention relates generally to connectors for employment in the communication of power in electrical systems carrying high amperage electricity such as Substation Modernization Platform cabling. More particularly, the invention relates to an improved female receptacle or receiving connector configured for a surrounding frictional engagement with a male connector in high amperage electric connections.

### 2. Prior Art

Single-pole cable connections positioned at the terminating ends of electric cables employed to communicate high amperage electrical power requirements are used in a variety of industrial settings, such as oil and other drilling platforms, stage power requirements at concerts, and other electric equipment requiring high power, such as carnival rides and the like. Because of the requirements of the electric motors, lights, and high power electric equipment powered by these flexible cables, the connectors positioned on terminating ends of power transmission cables and upon female receptacle for the cable connectors, are rated for extremely high voltage and current carrying capacity.

However, while current complimentary connections between male and female fittings of such high power cables has standardized to provide covered and insulated connectors adapted for complimentary engagement of cable ends to receptacles, such mating connections currently suffer from a number of issues relating to problems associated with misalignment of the cables with mating receiving receptacles during engagement thereof. Such is caused frequently by the fact that the male connectors and female receptors are covered by insulation rendering the internally housed conductors out of view during engagement between the male fitting to the female or mating receptacle. This misalignment during engagement is exacerbated when the connection is elevated above or below the waist of the person engaging the two components. The heavy cable and awkward elevated or lowered positioning compounded by the lack of the ability to view and align the insulated conductors, causes continual misalignments of the mating connectors during use. Additional problems are caused by the nature of the adjustability of the diameter of the male connectors which frequently will have been adjusted to a diameter exceeding the female connector to which it is to be engaged. As a consequence, workers having to deal with stubborn connectors, which will not properly mate due to oversized cable connectors and misalignments of the mating connectors, have a tendency to force the engagement between the male and female connectors using brute force, hammers, and other manners of forcing the male and female conductors into a cooperative power-communicating engagement.

As can be discerned, because the male and female conductors forming the connections for these engagements are conventionally formed of copper, the forcing of mis-aligned connectors together, such as by pounding, can cause physical damage to both connectors, and cause what is known as a “cold weld” between the male and female connections due to their being forced together while out of alignment. This can damage both the male and female connectors to the point they cannot be separated, or if they are separated using significant force, the are rendered useless for subsequent engagements, unless the users wish to damage an additional pair of connectors.

As such, their exists a continuing unmet need for an improved high amperage cable connector system which provides a female connector configuration adapted to remedy the issues caused by misalignment or mis-sizing of a male connector therewith. Such a device should ideally be configured to automatically self-aline an inserted male connector with the receiving female receptacle, to eliminate or minimize the physical damage and problems caused by such engagements while out of axial alignment. Further, such a device and system should provide for female receptacles, which easily accommodate a wide variety of male connector diameters which occur with great regularity with such systems, while still providing a stable electric connection capable of handling high amperage loads.

The forgoing examples of related art as to high amperage cabling, cabling connections, and the cable and panel connections, and limitations related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The device herein disclosed and described provides a solution to the shortcomings in prior art with regard to damaged connections from misalignment of male and female connectors in high power cabling connections, as well as the issues related to the wide possible variance in diameter of male connectors due to the adjustment component situated on each such male connector, and achieves the above noted goals through the provision of an improved female connector configured to work from many cycles of connection and disconnection with ease. The system provides such easy and secure connections despite any misalignment occurring from user handling during connection of a female receptacle with a male connector, or where a mismatch in size is present between an oversized male connector and the female receptacle.

The system herein provided for engagement of high amperage cable and panel connections, provides a plurality of female receptacle configurations, adapted to engage with male connectors of differing diameter as well as misaligned connection attempts between the two. A first improvement applicable to all of the modes of the female connector disclosed herein, is an annular plastic or polymeric insert positioned at the leading edge of a female receptacle which is configured to operatively receive a male electric connector inserted therein. The polymeric insert forms an annular leading edge surface for contact with the leading surface of the male connector being inserted within the axial cavity of the female receptacle. Used in combination with a polymeric component affixed to the leading end of the male connector, the annular leading edge allows two non conducting surfaces to engage and then begin self alignment before the conductor of the male connector comes into contact with the copper of the female receptacle.

One most preferred mode of the formed female receptacle which is configured for operable electric engagement with a conventional round male cable connector, is shown as a hyperbolic cylindrical grid formed of a plurality of flat conductive wires. The hyperbolic cylindrical shape is wider in diameter at opposite ends than a narrower portion therebetween. During insertion of a copper male conductor therein, the flat or planar wires forming a cylindrical receptacle are forced at the narrower middle portion to expand and provide a biased engagement to the inserted male connector at a central portion of the formed cylindrical engagement. The plurality of curved flat wires contact the inserted male conductor across a majority of their length, but will allow for expansion or contraction of the diameter of the cavity of the receptacle to accommodate inserted male connectors of differing diameters and circumference.

A second preferred mode of the device herein includes a female receptacle which is configured for operable electric engagement with a male cable connector, formed of a plurality of round wires in a hyperbolic cylindrical grid formed, defining the receiving cavity for an inserted male conductor. As with the mode formed of flat sided wires, the hyperbolic cylindrical shape provided by the round wires is wider in diameter at opposite ends and has a narrower diameter portion therebetween. During insertion of a copper male conductor therein, the round wires forming the cylindrical receiving cavity are forced at the narrower middle portion to expand and provide a biased engagement to the inserted male connector at a central portion of the formed cylindrical engagement. The plurality of round wires have contact surfaces which come into electric communication when in contact across most of the length of each such round wire, with the inserted male conductor. Using the curved configuration of the wires allows for expansion or contraction of the diameter of the formed receiving cavity of the receptacle which will thereby accommodate inserted male connectors of differing diameters and circumference.

In another preferred mode of the system herein, the circumferential wall of the female receptacle includes a cylindrical torsion spring positioned thereon formed of conductive material such as copper. The torsion spring is formed of a plurality of engaged metal members in a configuration allowing for circumferential expansion to accommodate the circumference of an inserted male conductor. Once so expanded as the male conductor passes through the central aperture defined by the torsion spring surrounding it, the torsion spring formed of the conductive components will collapse or form a biased contact against an exterior circumferential surface of the inserted male connector. The expansion and contraction of the torsion spring thus allows the receiving cavity of the female connector to accommodate male conductors which are adjusted to differing diameters, and still provide a secure electric communication between the female receptacle and male connector.

In another preferred mode of the system herein, an annular shaped body or receiving cavity is formed of conductive wire wound to a cylindrical shape. The circumference of the cylindrical shape of the wound wire, is flexible and deformable to accommodate larger and smaller diameter male conductors to communicate through an opening surrounded by the cylindrical shape formed by the coiled conductive wire. This mode of the system herein may require a relief to be formed into the receiving cavity of the female receptacle in a circular pattern surrounding the axis of the receiving cavity. The conductive annular insert formed of coiled wire, is operatively positioned within the relief in the wall of the receiving cavity, and thereafter will operatively engage with the circumference of a variety of sized male connectors inserted axially into the receiving cavity by deformation of the coils forming the annular body. The conductive wire forming the coiled body will thereafter be in a biased contact with the inserted male conductor thereby enhancing electric communication between the due for the duration of the connection.

With respect to the above description, before explaining at least one preferred embodiment of the herein disclosed invention in detail, it is to be understood that the connector for high amperage electric system invention herein is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed electrical connector system and method. It is important, therefore, that the claims be regarded as including such equivalent construction and methodology insofar as they do not depart from the spirit and scope of the present invention.

The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1 shows an isometric view of an annular body engaged forming an axial receiving cavity of a female electric connection formed of a hyperbolic cylindrical grid formed of a plurality of planar wires, which defines an internal axial cavity.

FIG. 2 shows an isometric view of the annular body of FIG. 1, formed of a hyperbolic cylindrical grid of a plurality of planar wires prior to an engagement into the axial receiving cavity of a female receptacle for male cable connectors.

FIG. 3 shows a prior art depiction of conventional cable connections between a male connector and female receptacle showing the cylindrical planar contact surfaces of each.

FIG. 4 shows a prior art depiction of conventional cable connections as in FIG. 3, depicting the constant problem of misaligned engagement of the male connector and receiving cavity components.

FIG. 5 shows perspective sectional view showing an annular body forming the receiving cavity shown in FIG. 8 and similar in construction to that of FIGS. 1-2 but formed of round wire, in an as-used position within the axial receiving cavity of a female receptacle formed of conductive material such as copper.

FIG. 6 depicts a perspective sectional view of the annular torsion spring mode of the device shown in FIG. 10, in an as-used positioning within the axial receiving cavity of a female receptacle.

FIG. 7 depicts the hyperbolic cylindrical grid forming an annular body from conductive material such as copper surrounded by a sidewall and ready for operative positioning to define an axial receiving cavity of a female receptacle.

FIG. 8 depicts a perspective view of the annular body herein formed from hyperbolic cylindrical grid of round conductive wires having an interior defining the receiving cavity for a male electric connector circumference.

FIG. 9 depicts a perspective view of an annular body for positioning within a recess formed into the sidewall of the axial cavity to thereby define a receiving cavity of a female receptacle.

FIG. 10 shows a perspective view of the annular torsion spring mode of the annular body herein as shown in the sectional view of FIG. 6.

FIG. 11 shows the annular body as in FIGS. 1 and 2 formed from a plurality of planar wires in a hyperbolic cylindrical grid, surrounding a receiving cavity adapted for contact with a circumference of a male electric connector inserted therein.

Other aspects of the present invention shall be more readily understood when considered in conjunction with the accompanying drawings, and the following detailed description, neither of which should be considered limiting.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

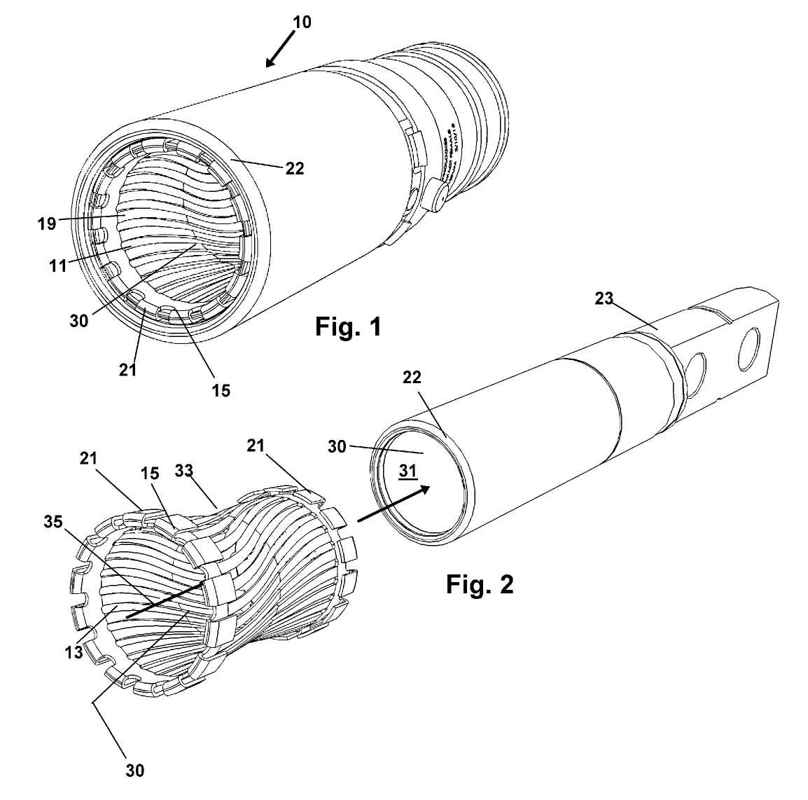

Now referring to drawings in FIGS. 1-11, wherein similar components are identified by like reference numerals, there can be seen in FIG. 1, an isometric view of a mode of the device 10 herein, having an annular body 15 as described herein in various modes, positioned in an as-used or operative positioning within the receiving cavity 30, for a female receptacle adapted for circumferential engagement around a male connector for high amperage electric equipment.

The depicted annular body 15 of FIG. 1 and FIG. 2, is formed in a preferred shape formed by the shaped wires 11, of a hyperbolic cylindrical grid structure. The wires 11 are held spaced in this shape by annular conductors 21 engaged to all the wires 11, at opposite ends of the plurality of shaped wires 11. The conductors 21 are crimped upon or otherwise firmly engaged to and hold each of the shaped plurality of wires 11. The wires are spaced from each other by parallel gaps 19 running in-between each planar wire 11 and held in the spaced arrangement across the gaps 19, by the engaged annular conductors 21.

In a preferred mode of the device 10, the wires as shown in FIGS. 1-2 and 11, the wires 11 are rectangular shaped with each having a continuous planar side surfaces 13, facing toward the center or axis running through the insert 15. This planar surface with the spaced wires 11 defining the depicted hyperbolic cylindrical grid structure, has been shown to yield a significantly enhanced electric contact and communication with an inserted male connector and run cooler and is preferred.

The exterior circumference of the annular conductors 21 of each annular body 15 as shown in FIG. 2, as with all others shown in other drawings herein is electrically engaged with a cable carrying current. While other electric engagements may be employed, one shown herein is forming the annular body 15 sized for operative tight frictional engagement and in electric communication, with an interior wall 31, thereby defining a receiving cavity 30 for the male connector. Such receiving cavities are positioned within the axial cavity of a female receptacle, and are positioned for receiving a removable engagement with male insertable electric connectors. The annular body 15, is shown in an as-used position, with conductor 21 engaged electrically with the wire cable, such as with a conductive interior wall 31, and with each wire 11, is ready to receive an annular body of a male connector, as shown in FIG. 1, or 5-6.

As noted above and shown in FIG. 2, the receiving cavity 30 for the male connector defined by the surrounding planar surfaces of the wires 11 forming the annular body 15, can accommodate many different sized male connectors in an operative electric engagement. This adaptive but highly conductive fitment, is provided by the ability of the wires 11 to flex into the gaps 19, and also toward a slight space between the wires 11 and the interior wall 31, when the male plug is axial inserted.

Also shown are an annular inwardly curved portion 33 of the wires 11 having interior surfaces of the wires 11 positioned closer to the center axis 35 running through the annular body 15.

Consequently, the wires 11 formed in this hyperbolic cylindrical grid structure are functionally able to accommodate larger male connectors and subsequently contract when such are removed. This ability to flex into the gaps 19 and toward the interior wall 31, also allows the wires 11 to flex, and form a biased contact against the surface of the inserted male connector yielding an enhanced electric contact. This biased contact is enhanced at the central inwardly curved portion 33 by increased deflection and metal memory resistance thereto.

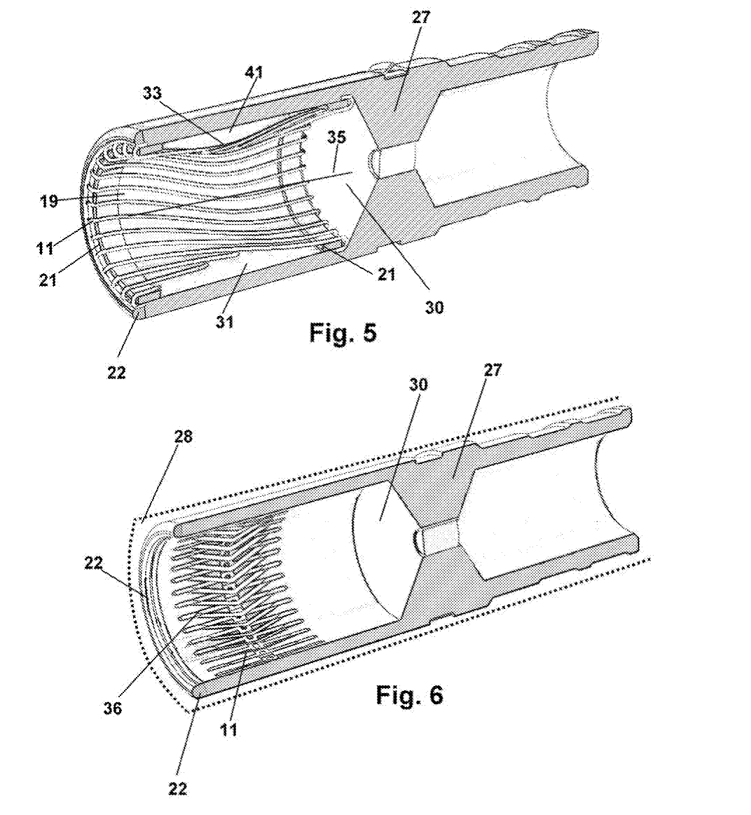

Also shown in FIG. 2, is a busbar 23 configuration for the female receptacle, and the body defining the annular polymeric annular insert 22, having an a curved annular leading edge and inclining angle 22a (FIG. 6) from front to rear, positioned at a first end, or the leading edge of the receiving cavity 30, of the female connector adjacent the conductor 21, opposite the second end thereof. The first end or leading edge of the body forming the polymeric annular insert 22, providing an annular curved ramp or incline 22a at the leading edge of the receiving cavity 30, functions as a guide to center the inserted male connector and prevent hard contact with the leading conductor 21 of the annular body 15 (FIGS. 4-5) and is a solution to the contact of the male conductor of conventional cables in prior art, contacting and damaging the 25 and the annular female receptacle 27 and cold welds therebetween.

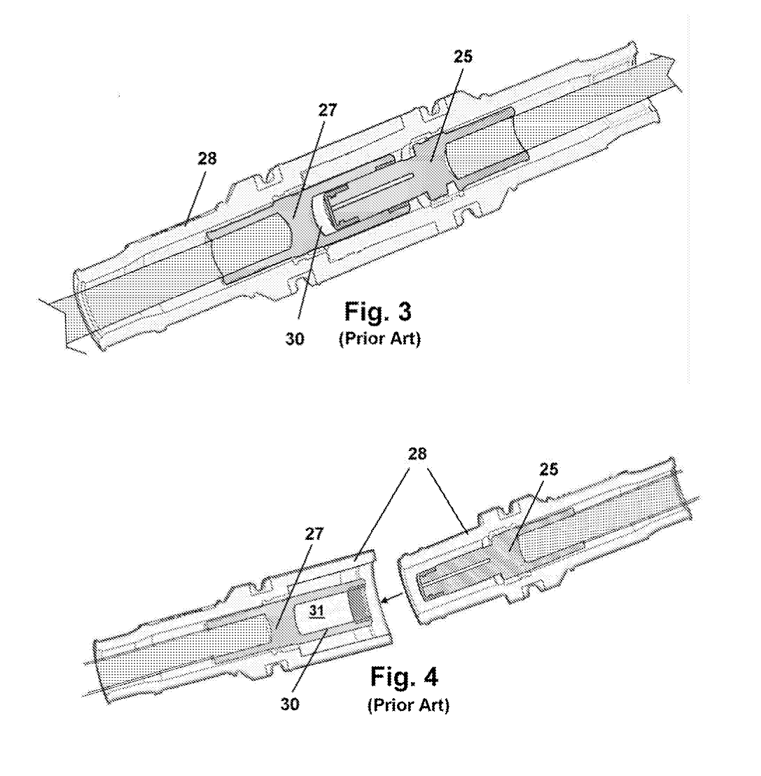

Shown in FIGS. 3 and 4, for reference, is a prior art depiction typical of prior art cable connection between a male connector 25 and female receptacle 27, showing the cylindrical planar contact of the male connector 25, having a circumference engaged against the cylindrical surface 31, defining the receiving cavity 30 of the female receptacle 27.

The hazards of the conventional mode of FIG. 3, are shown in FIG. 4 which is a prior art depiction of the constant problem of misalignment during engagement of the two components. As also can be seen, a conventional male connector 25 is hidden within the insulating cover 28 as is the receiving cavity 30 of the female receptacle 27. Such conventional configurations make it hard for users, even in optimum conditions, to engage both in axial alignment to avoid damage to either or both components over time.

FIG. 5 shows perspective sectional view showing a circumferential interior defining a receiving cavity 30, formed by the annular body 15 shown in FIG. 8 and similar in construction to that of FIGS. 1-2 but formed of round wire 11. Shown is this mode of the annular body 15 in an as-used position within and in operative contact with a wire or bus providing electric power, such as within the axial receiving cavity 30 of a conventional configured female receptacle formed of conductive material such as a copper cylindrical surface 31. The annular body 15 of this figures forms the deflectable receiving cavity 30 for a male connector 25, using round wires 11 in the same hyperbolic cylindrical grid structure of FIGS. 1-2 which as noted employed square wires with planar sides facing the axis (FIG. 2) of the formed cavity 30.

At the central portion of the wires 11 in-between the first end adjacent the opening to the formed receiving cavity 30 and the second end opposite thereto, and in-between the two annular conductors 21 holding them all in position, the wires 11 are shaped to bow inward and form an annular inwardly curved portion 33 of the receiving cavity 30, having interior surfaces of the wires 11 all closer to the center axis 35 running through the annular body 15.

The contact of the exterior conductive surface of a male connector first against the surface of the wires 11 at the reduced circumference of the annular curved portion 33 and second against the surface of the wires 11 on both sides thereof, yields a biased contact of the annular curved portion 33 when the wires 11 deflect forming a narrowed central portion 41 of the receiving cavity 30 formed by the wires 11. The wires 11 thereafter will deflect into the gaps 19 at the narrowed central portion 41 of a diameter of the receiving cavity 30 but having metal memory, will bias toward their original position. This yields an enhanced electric contact of the wires 11 with the circumference of the metal male connector 25 from the biased contact of the wires 11 therewith at the narrowed diameter central portion 41 in between the wider diameter of the receiving cavity 30 at the first end and second end of the annular body 15. Such a narrowing can be a reduction between 5 to 40 percent of the wider diameters of the receiving cavity 30 at the first and second end of the annular body 15.

Shown in FIG. 6 is a hyperbolic cylindrical grid of flat wires 11 forming an annular body 15 from conductive material such as copper surrounded by a sidewall. The annular body 15 is depicted ready for operative positioning within the axial receiving cavity 30 of a female receptacle 27. Also shown is the annular polymeric annular body 22 protecting the leading edge of the copper sidewall forming the receiving cavity 30.

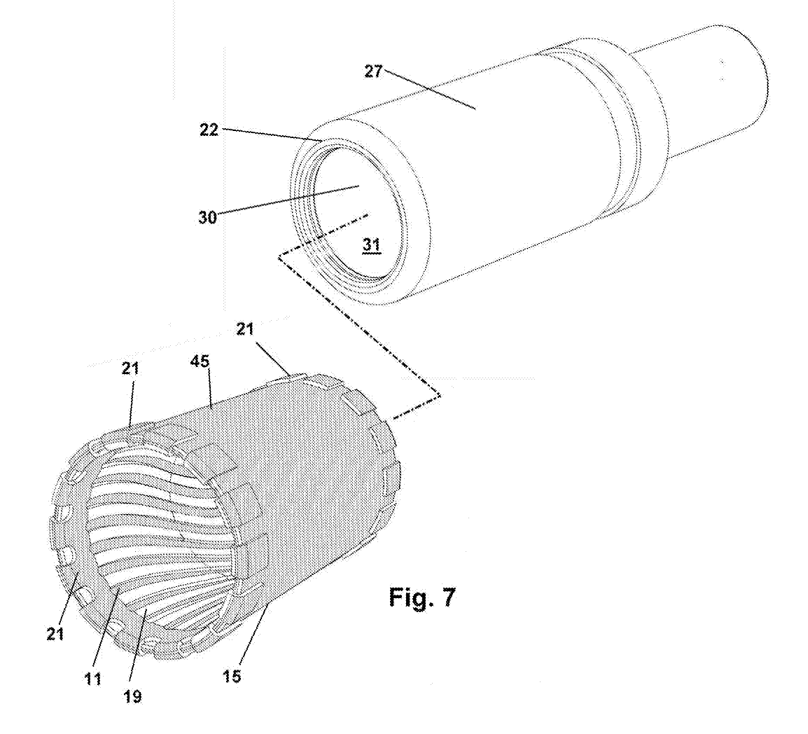

FIG. 7 depicts the hyperbolic cylindrical grid forming an annular body 15 from conductive material such as copper, of FIG. 1-2 or 5, surrounded by a sidewall 45, and ready for operative positioning in a female connector and forming the axial receiving cavity 30 of a female receptacle. The annular body 15 of FIGS. 1-2 and 5 include this sidewall 45 in operative electric engagement with a conductive cable, form the receiving cavity 30. One such electric contact with a cable may be by electric contact with the sidewall 31 which is electrically connected to the cable connected to this female receptacle.

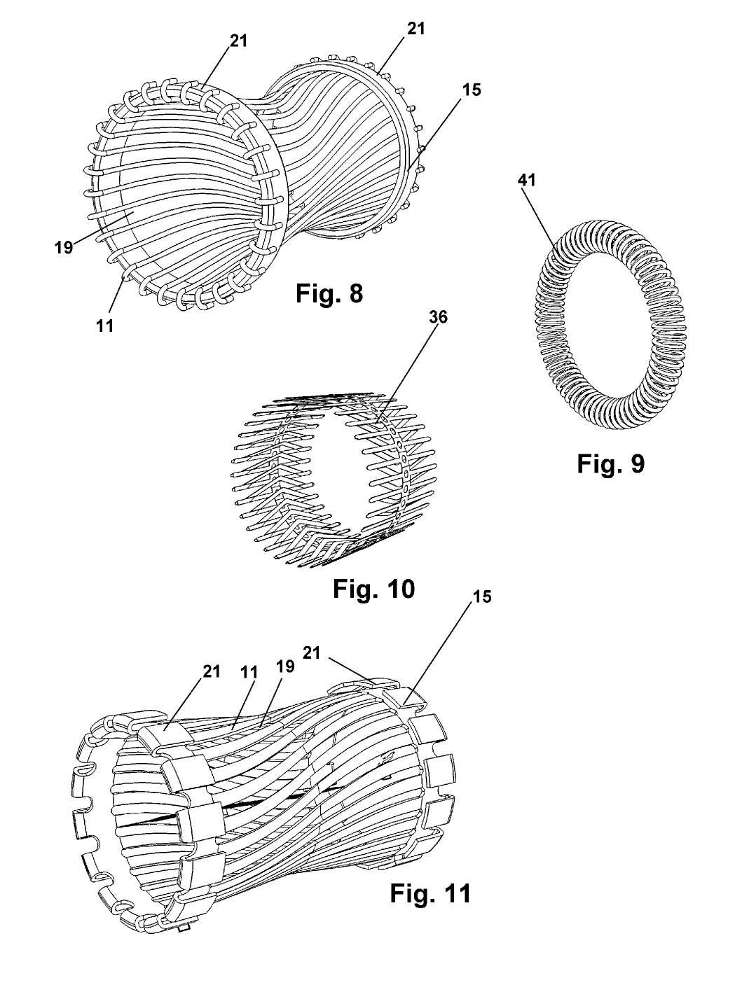

FIG. 8 depicts a perspective view of the full annular body shown in FIG. 5, formed from hyperbolic cylindrical grid of round conductive wires 11, unmounted and ready for operative engagement to provide the receiving cavity 30. FIG. 9 shows a perspective view of the annular body 15 configured from coiled wire, which is adapted for positioning within a recess formed into the sidewall 31 of the axial receiving cavity 30 of a conventional female receptacle shown as prior art herein. The narrowed central portion 41 of the diameter of the receiving cavity 30 is shown. FIG. 10 shows a perspective view of the annular torsion spring insert shown in FIG. 6, in an unmounted position. Finally, FIG. 11 shows an enlarged view of the annular body 15 as in FIGS. 1 and 2 formed from a plurality of planar wires 11 formed in a hyperbolic cylindrical grid, unmounted, and having an adjustable receiving area for a male insert running axially therethrough which varies in diameter with a smaller diameter central portion 41, as noted above.

It should be noted and anticipated that although the annular body system for female electric receptacles herein is shown in its most simple form, various components and aspects of the device may be differently shaped or slightly modified when forming the invention herein. As such, those skilled in the art will appreciate the descriptions and depictions set forth in this disclosure or merely meant to portray examples of preferred modes within the overall scope and intent of the invention, and are not to be considered limiting in any manner.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. An electric receptacle adapted for insertion and electric engagement of a cylindrical male electric connector, comprising:
an annular body having a first end and a second end and having an axis running through an axial receiving cavity;
said annular body formed of a plurality of spaced wires formed of electrically conductive material; and
a diameter of said receiving cavity at said first end of said receiving cavity adapted for insertion of said male electric connector into said receiving cavity.

2. The electrical receptacle of claim 1 additionally comprising:
an annular polymeric insert having an opening therein, positioned at said first end of said annular body;
said polymeric insert having a first edge adjacent said first end of said annular body;
said polymeric insert having a second edge opposite said first edge; and
a diameter of said opening at said second edge being wider than a diameter of said opening at said second edge.

3. The electrical receptacle of claim 1 additionally comprising:
said plurality of spaced wires being shaped to form a hyperbolic cylindrical grid structure.

4. The electrical receptacle of claim 2 additionally comprising:
said plurality of spaced wires being shaped to form a hyperbolic cylindrical grid structure.

5. The electrical receptacle of claim 3 additionally comprising:
said plurality of spaced wires forming said hyperbolic cylindrical grid structure being rectangular wires;
each of said rectangular wires having one planar surface facing said axis of said receiving cavity.

6. The electrical receptacle of claim 4 additionally comprising:
said plurality of spaced wires forming said hyperbolic cylindrical grid structure being rectangular wires;
each of said rectangular wires having one planar surface facing said axis of said receiving cavity.

7. The electrical receptacle of claim 3 additionally comprising:
said plurality of spaced wires forming said hyperbolic cylindrical grid structure being round wires;
each of said rectangular wires having a curved surface facing said axis of said receiving cavity.

8. The electrical receptacle of claim 4 additionally comprising:
said plurality of spaced wires forming said hyperbolic cylindrical grid structure being round wires;
each of said rectangular wires having a curved surface facing said axis of said receiving cavity.

9. The electrical receptacle of claim 1 additionally comprising:
said receiving cavity having a central portion situated in-between said first end and said second end of said of said annular body; and
said central portion of said receiving cavity having a diameter which is smaller than a diameter of said receiving cavity at one or both of said first end and said second end of said receiving cavity.

10. The electrical receptacle of claim 2 additionally comprising:
said receiving cavity having a central portion situated in-between said first end and said second end of said of said annular body; and
said central portion of said receiving cavity having a diameter which is smaller than a diameter of said receiving cavity at one or both of said first end and said second end of said receiving cavity.

11. The electrical receptacle of claim 3 additionally comprising:
said receiving cavity having a central portion situated in-between said first end and said second end of said of said annular body; and
said central portion of said receiving cavity having a diameter which is smaller than a diameter of said receiving cavity at one or both of said first end and said second end of said receiving cavity.

12. The electrical receptacle of claim 4 additionally comprising:
said receiving cavity having a central portion situated in-between said first end and said second end of said of said annular body; and
said central portion of said receiving cavity having a diameter which is smaller than a diameter of said receiving cavity at one or both of said first end and said second end of said receiving cavity.

13. The electrical receptacle of claim 5 additionally comprising:
said receiving cavity having a central portion situated in-between said first end and said second end of said of said annular body; and
said central portion of said receiving cavity having a diameter which is smaller than a diameter of said receiving cavity at one or both of said first end and said second end of said receiving cavity.

14. The electrical receptacle of claim 6 additionally comprising:
said receiving cavity having a central portion situated in-between said first end and said second end of said of said annular body; and
said central portion of said receiving cavity having a diameter which is smaller than a diameter of said receiving cavity at one or both of said first end and said second end of said receiving cavity.

15. The electrical receptacle of claim 7 additionally comprising:
said receiving cavity having a central portion situated in-between said first end and said second end of said of said annular body; and
said central portion of said receiving cavity having a diameter which is smaller than a diameter of said receiving cavity at one or both of said first end and said second end of said receiving cavity.

16. The electrical receptacle of claim 8 additionally comprising:
said receiving cavity having a central portion situated in-between said first end and said second end of said of said annular body; and
said central portion of said receiving cavity having a diameter which is smaller than a diameter of said receiving cavity at one or both of said first end and said second end of said receiving cavity.
